(19) United States
(12) Patent Application Publication
(10) Pub. No.: US 2012/0106290 A1
(43) Pub. Date: May 3, 2012

(54) STATIC MIXER COMPRISING A STATIC MIXING ELEMENT, METHOD OF MIXING A FLUID IN A CONDUIT AND A FORMULA FOR DESIGNING SUCH A STATIC MIXING ELEMENT

(75) Inventors: Han E. H. Meijer, Eindhoven (NL); Patrick D. Anderson, Selfkant (DE); Mrityunjay K. Singh, Heemskerk (NL)

(73) Assignee: Technische Universiteit Eindhoven, Eindhoven (NL)

(21) Appl. No.: 12/998,876

(22) PCT Filed: Dec. 10, 2009
(86) PCT No.: PCT/EP2009/008923

§ 371 Date: Nov. 22, 2011

(30) Foreign Application Priority Data
Dec. 10, 2008 (EP) 08021422.4

(51) Int. Cl. B01F 5/06

(52) U.S. Cl. 366/337

(57) ABSTRACT

Using the Mapping Method different designs of SMX motionless mixers are analyzed and optimized. The three design parameters that constitute a specific SMX design are: the number of cross-bars over the width of channel, Nx, the number of parallel cross-bars per element, Np, and the angle between opposite cross-bars θ. Optimizing Nx, somewhat surprisingly reveals that in the standard design with Np=3, Nx=6 is the optimum using both energy efficiency as well as compactness as criteria. Increasing Nx results in under-stretching and decreasing Nx leads to over-stretching of the interface. Increasing Np makes interfacial stretching more effective by co-operating vortices. Comparing realized to optimal stretching, we find the optimum series for all possible SMX(n) designs to obey the universal design rule Np=(⅔)Nx−1, for Nx=3, 6, 9, 12, . . .

Motionless mixers are widely used in a range of applications such as in continuous mixing of viscous liquids, blending, chemical reactions, and heat and mass transfer. Most designs of static mixers are geometrically very different, but operationally very similar. Their invention dates back to the middle of the previous century. One of the most used motionless mixers in industry is the Sulzer chemtech SMX™ static mixer.

As all continuous static mixers, the SMX™ is composed of multiple elements, periodically repeated in an axial direction and placed in a circular tube. The second element is an identical copy of the first element with 90° rotation in tangential direction. Each static element consists of multiple ‘X’ shaped cross-bars and the angle between these opposite cross-bars, θ is 90°. The standard Sulzer SMX™ element consists of 8 cross-bars (4 ‘X’ shaped pairs of crossed plates over the width of the channel). Flow is induced by applying a pressure difference. If we move, in a Lagrangian way, with the fluid through the tube, we experience the crossed bars acting as intermingled combs moving in opposite direction from one wall to another. The interface between two fluids, each occupying half the channel, is touched by these eight combs that move in two pairs of 4 combs perpendicular to its orientation, causing the interface to be stretched and folded eight times while moving through the first element. When the fluid moves through the second 90° rotated element, stretching and folding of all interfaces formed in the first element is performed in a perpendicular direction. Repeating the procedure eventually leads to exponential growth in the interface lengths, and in the standard design in interface grows at a typical rate of (8−1)^{Nelem}, with Nₑₗₑₘ the number of successive elements.

The Mapping Method is used to analyze mixing in the Sulzer SMX™ mixer. A typical standard SMX™ geometry with four elements is shown in FIG. 1. Each element consists of 8 crossing bars over the width, Nx forming 4-‘X’-shaped pairs of cross-bars, each at ±45° with the axis of the pipe. The central crosses are once copied both in positive and negative axial direction, resulting in, in total, three sets of parallel cross-bars, Np in an element. Every second element is rotated by 90° with respect to previous one. The aspect ratio, length to diameter I/D, is equal to one, with in the standard mixer D=52 mm, and a crossbar thickness of t=2 mm. The width of the crossbars next to the tube walls (W_{wall}) is 8 mm whereas all others are 6 mm wide. FIG. 1 depicts a standard SMX™ design with 8 cross-bars: 4 elements are shown. FIG. 2 depicts mixing elements for SMX™ mixers. FIG. 2a depicts a reference 2× design with 4 cross-bars (Nx=4) and 3 parallel cross-bars (Np=3). The angel between opposite cross-bars is 90°. FIG. 2b has an increased number of cross-bars over the width Nx=7 (Np=3). FIG. 2c has an increased number of parallel cross-bars Np=4 (Nx=4). FIG. 2d depicts a design with increased angel θ=120° between cross-bars (Nx=4, Np=3). Clearly, three design parameters may determine mixing in the SMX™:
Nx the number of cross-bars over the width of the channel (compare FIGS. 2a and 2b).
Np the number of parallel cross-bars (compare FIGS. 2a and 2c).
θ the angle between opposite cross-bars (compare FIGS. 2a and 2d).

Numerous experimental and computational studies have been reported in the literature regarding the performance of SMX™ mixers. See for example:
N F Shah and D D Kale “Pressure drop for laminar flow of non-Newtonian fluids in static mixers” Chem. Eng. Sci., 46:2159-2161, 1991;
H Z Li, Ch Fasol, and L Choplin “Hydrodynamics and heat transfer of rheologically complex fluids in a Sulzer SMX static mixer” Chem. Eng. Sci., 51:194-1955, 1996;
K Hirech, A Arhaliass, and J Legrand “Experimental investigation of flow regimes in an SMX sulzer static mixer. Ind. Eng. Chem. Res., 42:1478-1484, 2003;
H Z Li, Ch Fasol, and L Choplin “Pressure drop of Newtonian and non-Newtonian fluids across a Sulzer SMX static mixer” Trans IChemE, 75:792-796, 1997;
E. S. Mickaily-Hubber, F. Bertrand, P. Tanguy, T. Meyer, A. Renken, F. S. Rys, and M. Wehrli “Numerical simulations of mixing in an SMRX static mixer” Chem. Eng. J., 63:117-126, 1996;
D Rauline, J-M L Blévec, J Bousquet, and P A Tanguy “A comparative assesment of the performance of the Kenics and SMX static mixers” Trans IChemE, 78:389-396, 2000;
Shiping Liu, Andrew N. Hrymak, and Philip E. Wood “Laminar mixing of shear thinning fluids in a SMX static mixer” Chem. Eng. Sci., 61:1753-1759, 2006;
Shiping Liu, Andrew N. Hrymak, and Philip E. Wood “Design modifications to SMX static mixer for improving mixing” AIChE J., 52:150-156, 2006;
J. M. Zalc, E. S. Szalai, F. E. Muzzio, and S. Jaffer “Characterization of flow and mixing in an SMX static mixer” AIChE J., 48(3):427-436, 2002;
D Rauline, P A Tanguy, J-M L Blévec, and J Bousquet “Numerical investigation of the performance of several static mixers” Can J. Chem. Eng., 76:527-535, 1998;
   Tanguy and coworkers (see also references therein) performed computational studies on the SMX™ mixer, characterizing its performance and comparing it with different alternative motionless mixers. Zalc et al. computed mixing patterns in the Koch-Glitsch SMX static mixer and validated the computed relative standard deviation as a mixing measure with an experimental relative standard deviation; a good agreement is reported. Mickaily-Hubber et al. modified the design of a SMRX mixer by changing the crossing angles between two opposite cross-bars. They found the standard 90° crossing angle to be the optimum for mixing. Note that in a SMRX, R for reactive, the internal elements are composed of circular pipes. Hrymak and co-workers (see also references therein) performed numerical as well as experimental studies to characterize mixing for Newtonian as well as non-Newtonian fluids, and analyzed the effect of the number of cross-bars over width (Nx) ranging from 4 to 18, for constant Np=3. They found that a SMX™ design with 10 cross-bars provides the best mixing.

Most of the numerical mixing analyses reported in literature start with forward particle tracking and evaluate performance by defining statistical measures like the co-efficient of variation (COV) or the standard deviation (see Liu et al., Rauline et al., and Zalc et al.). However, mixing analysis using forward particle tracking brings several inherent drawbacks. First, it requires the tracking of a huge number of particles to generate high-resolution images at far downstream locations. Second, there is no guarantee that all the space of interest at the desired location will be completely occupied by particles, due to the fact that any ordered array of particles at the inlet becomes disordered at downstream positions. This leads to a loss of accuracy in quantification of mixing. In addition, proper care must be taken while computing a statistical measure like the coefficient of variation (COV): the measure must be independent of the initial number of particles for the given grid size on which the COV is computed. Also, the grid used to compute the COV must be sufficiently fine to capture a reasonable level of mixing characteristics. Some of the studies used a small injection area of tracers (10 or 20 percent of the inlet cross-section) and then follow them in the flow field. The better the distribution of tracers at a required downstream position, the better is the mixer (see Rauline et al., Liu et al.). Here, we will show that mixing analyses using a small injection area can sometimes lead to erroneous conclusions regarding the performance of different layouts. One of the important suggestions mentioned by Liu et al. indeed reflected the requirement of a larger number of passive particles to characterize all the designs in an accurate way.

Summarizing all the above aspects, we can conclude that a more advanced method is required to overcome the above mentioned disadvantages of forward particle tracking approaches. In this respect, we may show that the Mapping Method, which is based on backward particle tracking (See M K Singh, T G Kang, H E H Meijer, and P D Anderson “The mapping method as a toolbox to analyze, design and optimize micromixers” Microfluidics and Nanofluidics, 5:313-325, 2008 and M K Singh, P D Anderson, M F M Speetjens, and H E H Meijer “Optimizing the Rotated Arc Mixer”AIChE J., 54:2809-2822, 2008) may be a useful tool.

It's an object of the invention to provide an improved static mixer.

According to the invention there is provided a static mixer provided with a mixing element for use in a channel, wherein the mixing element comprises crossbars and the number of parallel crossbars Np along the length of one element and the number of crossbars over the width of the mixing element Nx are related by the formula:

Np=(⅔)Nx−1.

The mixer may comprise multiple mixing elements, each mixing element comprising crossbars according to the formula. The length of the mixing element is parallel to the flow direction of the liquid through the mixing element in the channel. The width of the mixing element is perpendicular to the flow direction of the liquid through the mixing element in the channel.

The mixing element may comprise crossbars according to the formula (n, Np, Nx)=(n, 2n−1, 3n), wherein n is a positive integer for example 1, 2, 3, 4, 5, 6, etc. n may be the number of parts the height of the channel and the width of the channel can be split in. Subsequent mixing elements of the multiple mixing elements may be rotated with respect to each other 90° around an axis parallel to the length of the element. N may be an integer larger or equal to one and n may be the number of crossbars which can be provided in the length of the mixing element parallel to a flow direction in the channel. N may be the number of crossbars which can be provided in a direction perpendicular to the length and the width of the mixing element.

The invention further relates to a method of mixing a fluid in a channel comprising:

inducing a flow to the fluid through the channel; and mixing the liquid with a mixing element, wherein the mixing element comprises crossbars and the number of parallel crossbars Np along the length of one element and the number of crossbars over the width of the element Nx are related by the formula:

Np=(⅔)Nx−1.

The invention further relates to use of the formula in the design of a mixing element with crossbars for a static mixer.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a standard SMX™ design with 8th cross-bars: 4 elements are shown;

FIG. 2 depicts design parameters of SMX™ mixers;

FIG. 3 depicts qualitive mixing profiles after each element for SMX™ design with different number of cross-bars per element;

FIG. 4 discloses a graph which quantifies mixing using the flux weighted intensity of segregation;

FIG. 5 depicts a graph analysing mixing according to Liu et al.;

FIG. 6 depcits results for the SMX™ design where Nx=16, and Np=3 are compared to the design with Nx=16 and Np=9;

FIG. 7 depicts mixing for SMX™ mixers with 8 and 9 cross-bars over the width, Nx=8 (FIG. 7a) and Nx=9 (FIG. 7b): the top of each showing mixing profiles for original SMX™ mixers with 3 parallel cross-bars, Np=3, and bottom showing mixing profiles for an increased number of parallel cross-bars, Np=5;

FIG. 8a compares mixing profiles for different values of the crossing angle θ: with θ equals 90°, 140°, 135°, and 120°, for different designs of the SMX and FIGS. 8b to g show simulation of mixers with less than 16 crossbars which make use of a Wall effect, and FIG. 8h shows a (n, Np, Nx)=(1, 1, 6) mixer;

FIG. 9 depicts the influence of odd numbers of cross-bars and the ratio of Np and Nx on mixing using the flux-weighted intensity if segregation and comparing Nx=8, Np=3 with Nx=9, Np=3 and Nx=8, Np=5 with Nx=9, Np=5;

FIG. 10 discloses schematics of SMX™ series characterized by n=1, 2, 3, 4, and 5, demonstrating the values of (n, Np, Nx)=(n, 2n−1, 3n) that all give optimum interface stretching per element;

FIG. 11 depicts the (n, Np, Nx)=(1, 1, 3) configuration, see FIG. 11a, and FIG. 11b further shows the (n, Np, Nx)=(3, 5, 9) configuration;

FIG. 12 depicts mixing in the SMX™ series (n, Np, Nx)=(n, 2n−1, 3n) for n=1, 2, 3, and 4;

FIG. 13 depicts the computed flux-weighted intensity of segregation versus (a) and (c) pressure drop and (b) and (d) axial length; (a) and (b) calculated form the mapping results; (c) and (d) calculated using Eqs. (5) and (6) respectively;

FIG. 14a discloses flow through 5 successive identical (n, Np, Nx)=(1, 1, 3) mixing cubes on a row and FIG. 14b depicts the flow through successive identical mixing cubes on a row;

FIG. 15 depicts the effect of the number of parallel cross-bars Np on interface stretching in Nx=9 mixers;

FIG. 16 depicts designs of the hierarchical SMX™ mixer showing the combination (a) 1, 1R, 2, 2R, 3, 3R, 4, 4R, 5, 5R (b) 1, 2R, 3, 4R, 5, 6R, with the number indicating the value of n in the (n, Np, Nx)=(n, 2n−1, 3n) designs and R stands for 90° rotation in tangential direction;

FIG. 17 depict designs of a variety of SMXⁿ: (a) the building blok BBⁿ of the (n, Nₚ, Nₓ)=(3, 5, 9) configuration, (b) and (c) the compact SMXⁿ design summarized in the formula n×BBⁿ+Nₑₗₑₘ×(BBⁿ(R)−BBⁿ), with Nₑₗₑₘ the number of elements and BBⁿ (R) the 90° rotated BBⁿ;

FIG. 18 depicts mixing in 4 elements of the optimal design SMXⁿ, mixing snapshots after each 1/3 element of the (n, Nₚ, Nₓ)=(3, 5, 9) based SMXⁿ mixer with θ=120°, build up with planes of n² cubes, normal (N) and 90° rotated (R), in the sequence: (Element 1), (Element 2), (Element 3), (Element 4): (N, N, N), (R, N, R), (N, R, N), (R, N, R);

FIG. 19 depicts the effect of injection location on mixing in SMXⁿ of FIG. 17;

FIG. 20 depicts the determination of injection location to achieve best mixing using different initial conditions;

FIG. 21 depicts a comparison between SMX(n) and SMXⁿ (a) Intensity of segregation versus dimensionless pressure drop and (b) versus dimensionless length; and,

FIG. 22 depicts different motionless mixers 22a the Kenics mixer (RL configuration), 22b the Ross LPD mixer (RL configuration), 22c the standard Sulzer SMX™ mixer (the (n, Np, Nx)=(2, 3, 8) configuration), and finally two examples of the new design series of the most efficient SMX(n) mixer with (n, Np, Nx)=(n, 2n−1, 3n) shown here in their rectangular configuration 22d the working horse (1, 1, 3), and 22e the compact (3, 5, 9) according to the invention.

The question is posed whether a change in one of the three design parameters of the SMX™ can yield better mixing or worse, and the next question is how these parameters can be tuned to achieve an optimum in mixing. For all cases we need an accurate three-dimensional velocity field, and Fluent 5 is used to solve the Navier-Stokes equations. The inlet and outlet sections are composed of two empty circular tubes, each with a length of two times the diameter of the cylinder to avoid the effect of a developing flow. The mesh is generated using Gambit and contains 421,408 nodal points and 2,1341,86 first-order tetrahedral elements for the standard SMX™ design. In most of the cases investigated here, the geometry becomes more complex and, hence, mesh sizes of typical around 6 million elements and 1 million nodal points are used. At the inlet a fully developed velocity profile is taken, and a no slip boundary condition is applied at the tube walls and surfaces of the static elements. The fluid is assumed to be Newtonian with density and viscosity equal to 846 kg/m³ and 1 Pa·s, respectively. The average inlet velocity is 0.01 m/s, yielding a Reynolds number of 0.44. Hence, the flow is clearly in the Stokes regime.

Optimization of the SMX™ mixer is cumbersome, since any change in the design requires re-computation of velocity field as well as of the mapping matrices. This in contrast with the optimization of lid-driven cavity flow (See P. G M Kruijt, O S Galaktionov, P D Anderson, G W M Peters, and H. E H Meijer “Analyzing mixing in periodic flows by distribution matrices: Mapping method” AIChE J., 47(5):1005-1015, 2001) and the Kenics mixer (See O. S. Galaktionov, P. D. Anderson, G. W. M. Peters, and H. E. H. Meijer “Analysis and optimization of Kenics mixers” Int. Polym. Proc., XVIII(2):138-150, 2003) where a few mapping computations were sufficient to analyze various designs.

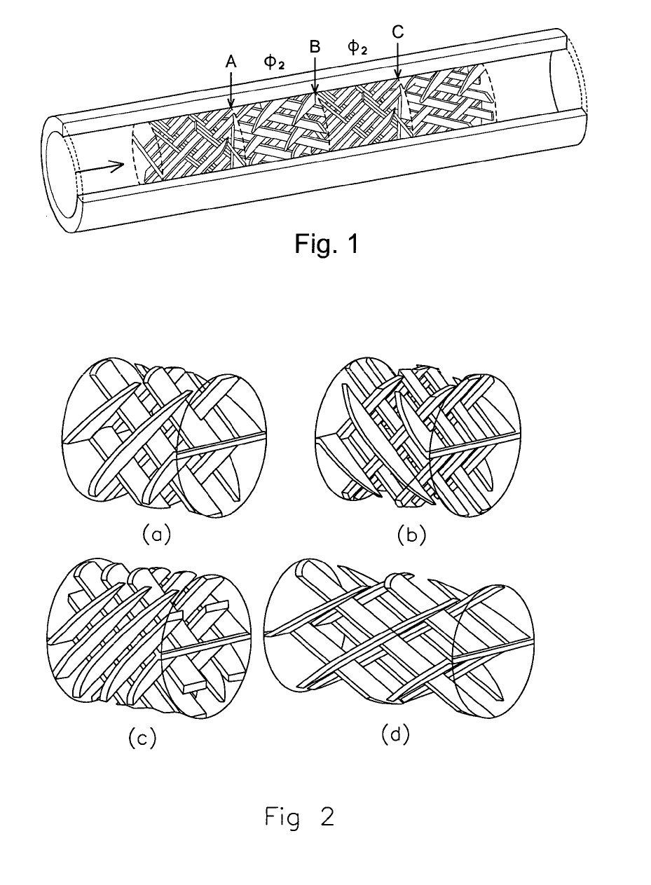

The computationally simple-to-implement approach to obtain the mapping matrix based on backward particle tracking (see M K Singh, T G Kang, H E H Meijer, and P D Anderson, The mapping method as a toolbox to analyze, design and optimize micromixers” Microfluidics and Nanofluidics, 5:313-325, 2008; M K Singh, P D Anderson, M F M Speetjens, and H E H Meijer “Optimizing the Rotated Arc Mixer” AIChE J., 54:2809-2822, 2008; T G Kang, M K Singh, T H Kwon, and P D Anderson, Chaotic mixing using periodic and aperiodic sequences of mixing protocols in a micromixer” Microfluidics and Nanofluidics, 4:589-599, 2008) is used. For the calculation of a mapping matrix, the cross sectional area is divided into a grid consisting of 200×200 cells, and the number of particles per cell (NPPC) used is ranging from 25 to 100 (applying a 10×10 array) and, therefore, in total 4×10⁶ particles are tracked in the flow field. Note that the NPPC should be sufficient to obtain a converged quantitative mixing measure, the flux-weighted intensity of segregation I_{d} (see M K Singh, T G Kang, H E H Meijer, and P D Anderson “The mapping method as a toolbox to analyze, design and optimize micromixers” Microfluidics and Nanofluidics, 5:313-325, 2008). To do a full analysis of mixing, we compute two separate mapping matrices Φᵢ (i=1, 2) representative for two types of elements of a typical SMX design as shown in FIG. 1 with its (1, 2, 1, 2, . . . , etc) sequence of elements from left to right. The A-B region is denoted as matrix Φ₂ and the B-C region as matrix Φ₁. Only the two middle elements are used in computing mapping, assuming that the flow field is developed, such that the periodic structure indeed is represented by these two elements. The matrices are used to obtain the concentration evolution after a number of elements Nₑₗₑₘ, via a computationally very fast matrix-vector multiplication:

C¹=Φ₁C⁰, C²=Φ₂C¹, Cⁿ=(Φ₁(Φ₂( . . . (Φ₁(Φ₂C⁰))))/Nₑₗₑₘtimes (1)

where C⁰ is initial concentration distribution.

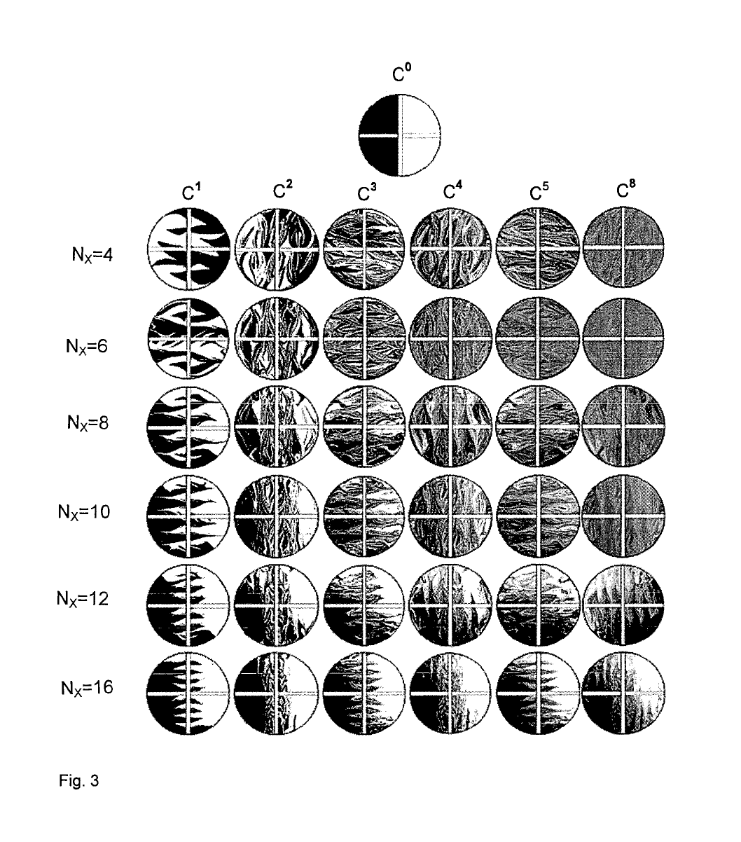

Mixing profiles for designs (fixed Np=3 and θ=90°) with a different number of cross-bars Nx are shown in FIG. 3. We start the analyses of these results with the standard design with 8 cross-bars (the third row in FIG. 3). As evident from the mixing profile after 1 element of mixing C¹, 4 black and 4 white striations with 7, which is the result of (8−1), interfaces in between are found, and hence this mixer results in an interface increase with a factor (8−1)^{Nelem} after having passed a Nₑₗₑₘ numberv, of elements. But, of course, this is an idealized situation and some deficiencies are readily observed by examining C¹ and the mixing profile after the next element C². For example, C¹ reveals that interfaces are not covering the whole cross-section and the thickness of striations is not uniform in the cross-section. Finally, we observe more “white” in top-right part of the cross-section and more “black” in the bottom-left part. This situation rotates by 90° in each element. This leads to a non-uniform distribution in striations, which is evident even after 8 elements of mixing, C⁸ showing the same pattern, of course with a change in intensity. All this becomes much more clear by investigating the mixing profiles for 10, 12, and 16 cross-bars (the last three rows in FIG. 3), where more inhomogeneity results and mixing by interface stretching is more and more restricted to the center part of the tube. For example, the SMX with Nx=16 cross-bars shows the initial segregation of white and black material in left and right parts even after 8 elements of mixing, see C⁸.

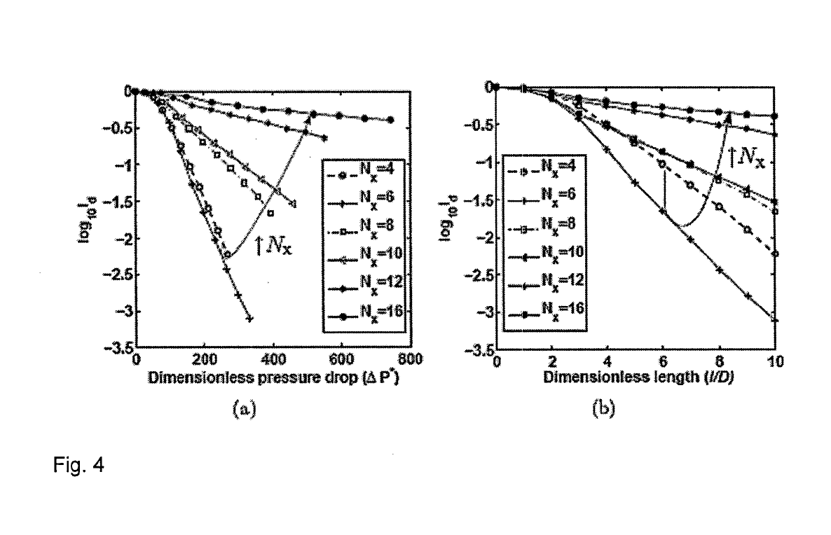

Next, we investigate mixing in designs with less cross-bars than in the standard SMX™, Nx=4. C¹ and C² now reveal that the interface stretching per element is that high that it leads to overstretching, and more white material is transported from the right into the left part, while the opposite is true for the black material. Over-stretching for Nx=4 and under-stretching for Nx≧8, suggest that a design with 6 cross-bars could be superior and indeed the C¹ of the design with Nx=6 cross-bars (row 2) shows interfaces covering almost the total cross-section and, therefore, a more uniform distribution of striations is found as compared to any of the other designs in FIG. 3. Since an increase in Nx increases the pressure drop per element (see Shiping Liu, Andrew N. Hrymak, and Philip E. Wood “Laminar mixing of shear thinnning fluids in a SMX™ static mixer” Chem. Eng. Sci., 61:1753-1759, 2006) a quantitative comparison must be made using the flux-weighted intensity of segregation; results are shown in FIG. 4. FIG. 4 discloses a graph which quantivies mixing using the flux weighted intensity of segregation versus (a) pressure drop and (b) dimensionless length I/D. Pressure drop is defined here as ΔP*=ΔP/ΔP₀, where ΔP is the pressure drop in SMX™ per element and ΔP₀ is the pressure drop in the pipe with a length equal the length of one element of SMX with same diameter as SMX™. Indeed, also this quantitative plot reveals what it was observed qualitatively: the SMX™ mixer with Nx=6 is superior to all others, although also the mixer with 4 cross-bars performs almost as good. Sometimes, not energy efficiency, as measured as the dimensionless pressure drop, is relevant to compare mixer designs but instead compactness, aiming at a minimum length, see FIG. 4b. Surprisingly, also according to this criterion of compactness, Nx=6 is the best.

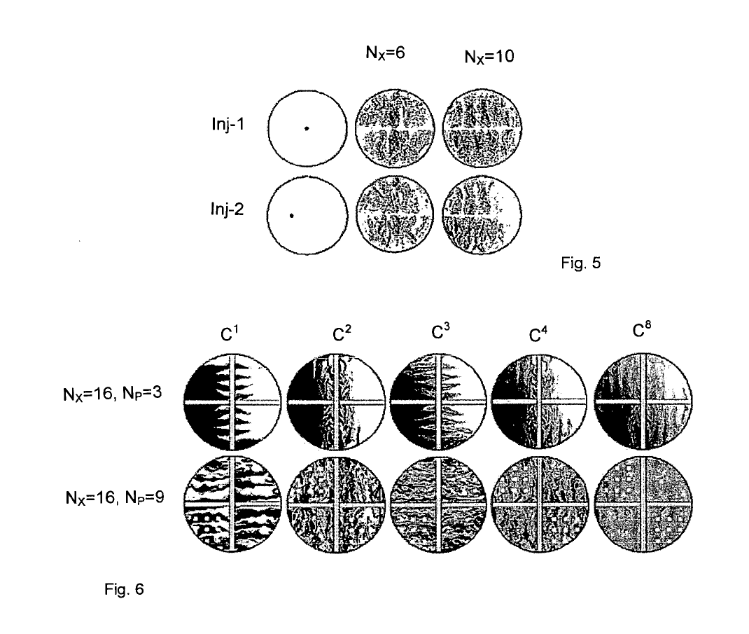

These findings are different from the results of Liu et al. who reported that 10 cross-bars was optimum. To investigate the reason for the differences found, we repeat their computations using two designs of the SMX™: Nx=6 and 10. Like Liu et al., we injected 40,000 particles uniformly distributed in a circle of radius 1 mm placed at the origin (0,0,0). Next, we shifted the position of injection to the left side (−0.01,0,0) (note that D=0.026 m), see FIG. 5.

FIG. 5 depicts a graph analysing mixing according to Liu et al.: effect of injection location on mixing profiles for two designs of SMX™: Inj-1 reperesents injection of particles at (0,0,0), while Inj-2 represents injection of particles at (0.01,0,0). Particle tracks are shown after 4 elements of mixing for two designs Nₓ=6 and 10. The top part of FIG. 5 reproduces the results reported in Liu et al. and, indeed, comparing mixing profiles here reveals that Nx=10 performs better than Nx=6. In contrast, the bottom part of FIG. 5 leads to a different conclusion regarding the optimum and Nx=6 is better. Apparently, two contradictory conclusions can be drawn and, therefore, using a mixing quality criterion that is based on the injection of a large but still limited number of tracers in a small area does not give reliable results. Therefore, we will keep using interfacial stretching, and computed flux weighted, cross sectional area integrated, intensity of segregation, in our investigations of finding the optimum designs in the different SMX™ series.

From the previous section, it becomes obvious that SMX™ designs with Np=3 and Nx>6 under-stretch the interface and, as the number of cross-bars increases, mixing rapidly deteriorates. We now consider the worst design with Nx=16 in an attempt to learn how to improve mixing in this extreme case. Transverse interfacial stretching is clearly not sufficient and, therefore, ways should be found to increase the efficiency of the transverse components of the velocity. The number of parallel cross-bars, Np, decisively influences this aspect, see FIG. 6 where results for the SMX design with Nx=16, and Np=3 are compared to the design with Nx=16 and Np=9. Evidently, the design with Np=9 is able to effectively stretch all interfaces to cover the total cross section and the mixing profiles are much more close to a perfect bakers transformation. Of course any increase in the number of parallel cross-bars leads to an increase in pressure drop. Therefore, we will have to analyze mixing using either energy efficiency or compactness as a criterion.

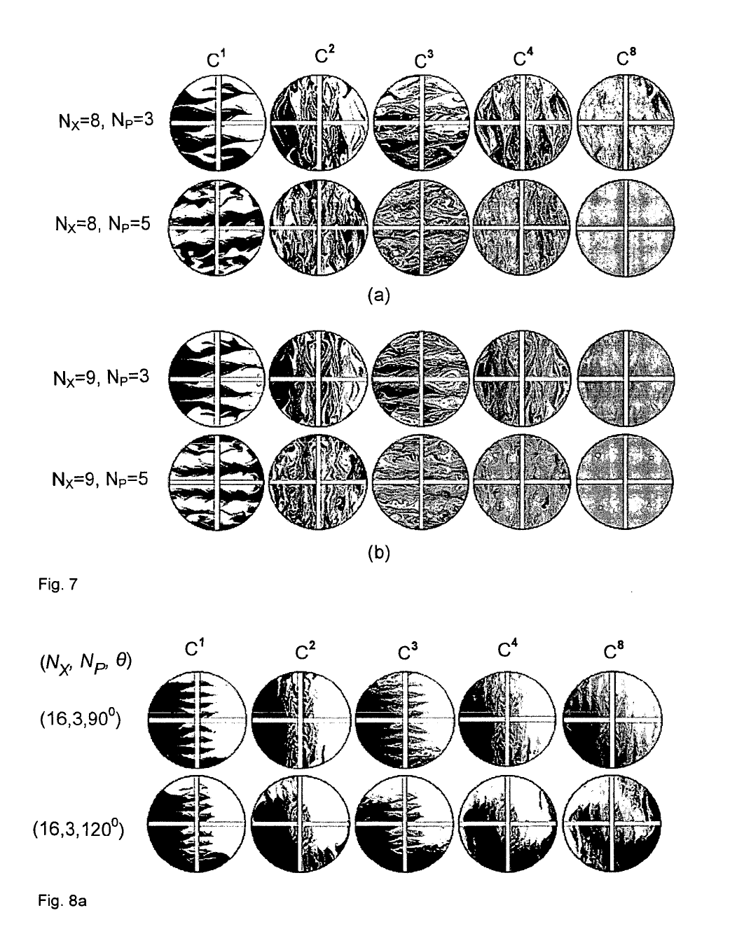

If we now compare the results of the two designs that—thus far—showed almost ideal interfacial stretching (no under-stretching, neither over-stretching) and thus the best mixing; Nx=6, Np=3 (see FIG. 3) and Nx=16, Np=9 (see FIG. 6) and realizing that Np because of symmetry reasons should be odd, see FIG. 2, the relation Np=(⅔)Nx−1 is suggested. This is checked in FIG. 7a by comparing the standard SMX Nx=8, Np=3 (shown at the top) with Nx=8, Np=5 at the bottom and in FIG. 7b by comparing Nx=9, Np=3 with the modified versions Nx=9, Np=5 that roughly obey this relation. Indeed, compared to the standard SMX both designs with Np=5 give superior interface stretching and, as a result, superior mixing.

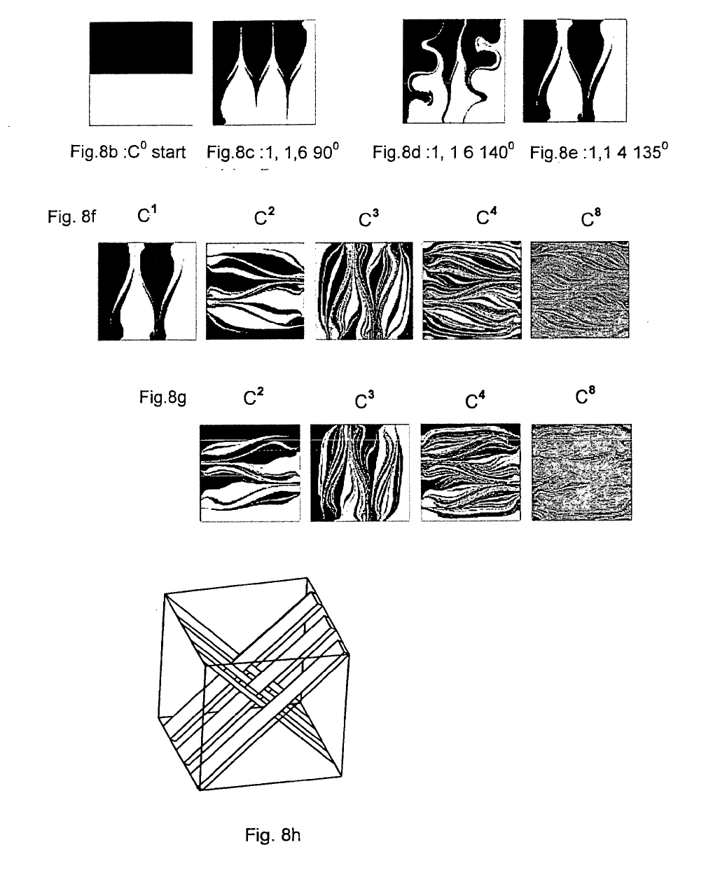

As may be known from our Ross LPD analyses M K Singh, T G Kang, P D Anderson, H E H Meijer, A N Hrymak, “Analysis and optimization of Low-Pressure Drop (LPD) static mixers” AIChE J., 55(9), 2208-2216, 2009, we can also change interface stretching by changing the angle between opposite cross-bars. Increasing the angle increases the axial length (I/D>1) and, therefore, the transverse components act for a longer axial length, and therefore longer time, before re-orientation of flow occurs. To investigate this design aspect also for the SMX, we again first take the extreme design with Nx=16, Np=3 where mixing was worst. FIG. 8a compares mixing profiles for θ is 90° (top) and 120° (bottom) revealing that little influence is found since increased interface stretching is limited to regions close to the tube walls only, basically making the concentration distribution less homogeneous. The only result is a decrease in pressure drop ΔP* per element of a factor of 1.3 at cost of axial length of course, that increases with a factor of 1.7. However, simulations with simpler mixer designs with less than this high number of 16 cross bars reveal that use can be make of this close to the wall effect. This is illustrated in FIGS. 8b-g. FIG. 8b shows the initial configuration where black fluid flows on top of white fluid in a 50%-50% ratio into the, this time square chosen, cross section of the mixer. FIG. 8c shows the distribution, and interface stretch, after one element of the so-called (1, 1, 6) mixer with Np=1 and Nx=6. Interface stretching is insufficient. FIG. 8d shows that increasing the crossing angle from 90° to 140° does not help in improving layer distribution and interface stretch. In contrast, for the (1, 1, 4) configuration with Np=1 and Nx=4, larger crossing angles θ improve both distribution and stretch, as demonstrated here for the θ=135 degrees crossing angle of this (1, 1, 4) mixer. Improved interface stretching and a more uniform layer distribution in every step result, as expected, in much improved overall mixing patterns. This is shown for the (1, 1, 4) configuration with Np=1 and Nx=4 and θ=135° in FIG. 8f where every second mixing element is rotated over 90° and in FIG. 8g, where every second mixing element is rotated over 90° and mirrored to break symmetry, FIGS. 8f and 8g give similar results, indicating that the mirroring is, for the SMX geometry, not necessarily, while it is in the Kenics and Ross LPD and LLPD geometries.

FIG. 8h shows a three dimensional figure of a (n, Np, Nx)=(1, 1, 6) mixing element with a θ=90 degrees. In a side view one cross in the length of the mixing element and one cross in a direction perpendicular to the length and the width of the mixing element is visible. The mixer has one parallel cross bar in a side view hence Np=1. In a front view of the mixing element with a viewing direction parallel to the flow through the mixing element, the mixing element has in the width of the mixing element six crossbars Nx=6.

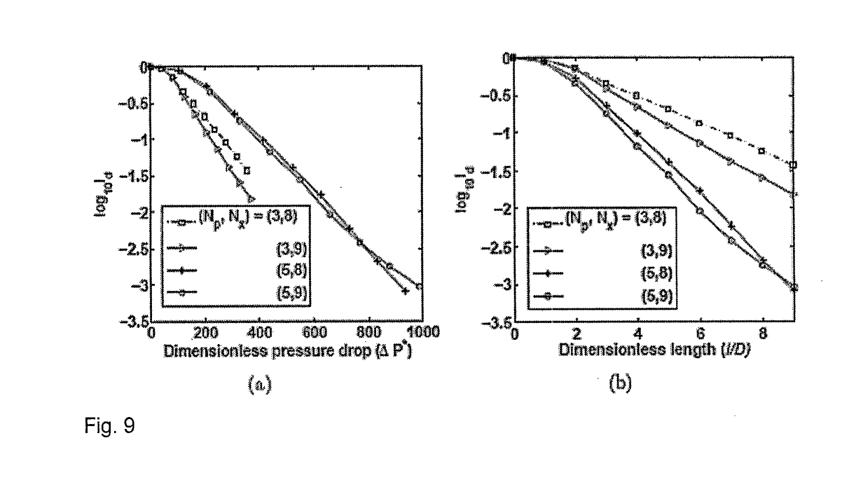

All existing SMX designs have a Nx which is even e.g. Nx=4, 6, 8, 10, etc. and a Np that is odd, usually Np=3. The drawback of an even Nx is as already illustrated in the C¹ and C² mixing profiles in FIG. 3: almost never a equal distribution of black and white striations over the cross-section is realized, indicating that the ideal bakers transformation is not yet approached. An odd number of cross-bars Nx provides better mixing, see FIG. 7, while FIG. 9a illustrates that in spite of a higher pressure drop per element for the Nx=9 design, its efficiency is still better. Besides that, FIG. 9b shows the superiority of the Np=5 in this Nx=8-9 layout in terms of compactness.

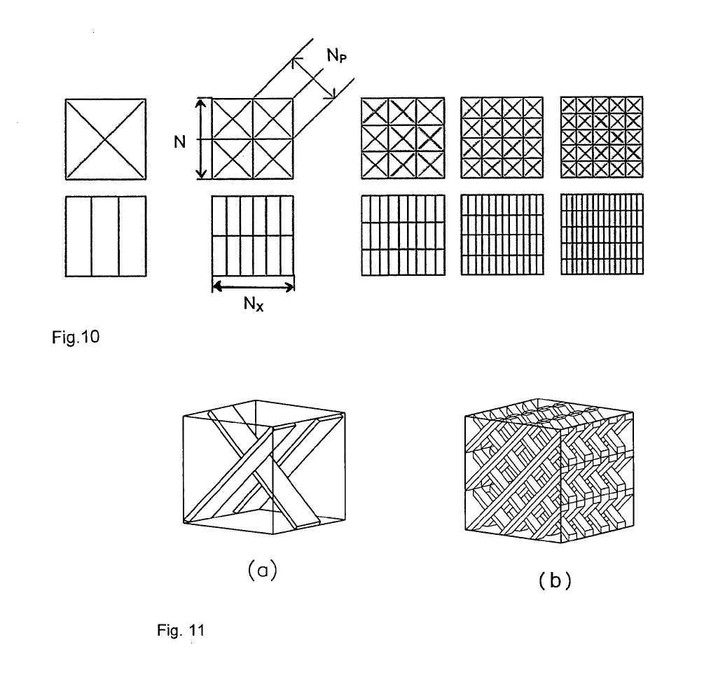

Now, we are ready to identify the optimum SMX™ design. As before in FIGS. 4 and 9, we will use both criteria: (1) energy (measured with the pressure drop needed) and (2) compactness (measured with dimensionless mixer length). First let us consider the number of parallel crossbars within one element, Np, which, given the central cross and the symmetry around that one, per definition is odd: Np=1, 3, 5, 7, 9, etc, see FIG. 10. FIG. 10 discloses schematics of SMX series characterized by n=1, 2, 3, 4, and 5, (from left to right) demonstrating the values of (n, Np, Nx)=(n, 2n−1, 3n) that all give optimum interface stretching per element. The top portion of FIG. 10 gives a sideview on a mixing element perpendicular to the flow direction of a fluid being mixed in the mixer and shows the crossbars visible as crosses. The number n represents the number of crosses in the length of a mixing element parallel to the flow direction and the number of crosses in a direction perpendicular to the length and the width of the mixing element. For n=2 (the mixer second from the left) it is shown in the top portion of FIG. 10 that it has in side view two crosses in the length of the mixing element and two crosses in a direction perpendicular to the length and the width of the mixing element. The same mixer has three parallel cross bars in a side view. It is clear that the parallel crossbars split the channel in n parts according to:

Np=2n−1 (2)

with n=1, 2, 3, 4, 5, etc. The bottom portion discloses a front view of a mixing element with a viewing direction parallel to the flow through the mixing element. If n=2 the front view which is also equal to the width of the channel is provided with six crossbars. Now we check the influence of the number of crossbars over the width of the element, Nx. In section 3.2 we concluded that the best SMX designs suggest the relation:

Np=(⅔)Nx−1 (3)

which using Eq. (2) yields:

Nx=3n (4)

The stunning conclusion is that the basic unit of the SMX, the working horse so to say, which is the most left mixer depicted in FIG. 10, and which is found for n=1, is the (n, Np, Nx)=(1, 1, 3) configuration, see FIG. 11(a). FIG. 11(b) further shows the (n, Np, Nx)=(3, 5, 9) configuration. A side view on FIG. 11a shows one crossbar (see also FIG. 10 most left mixer top view) the crossbar comprises two parallel crossbars and one crossbar in between the crossbars in opposite direction forming a cross. We now also understand the front view in the bottom portion of FIG. 10 which shows a front view of the three crossbars in FIG. 11a.

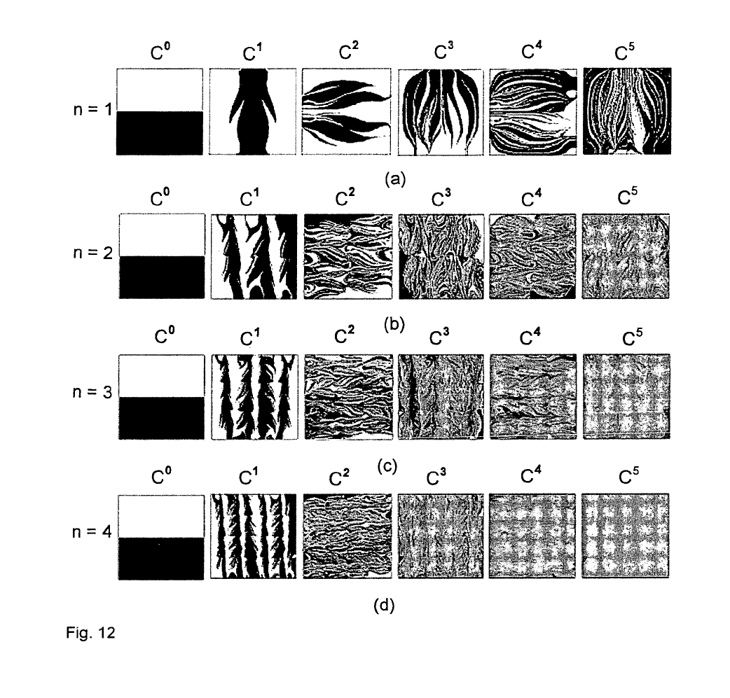

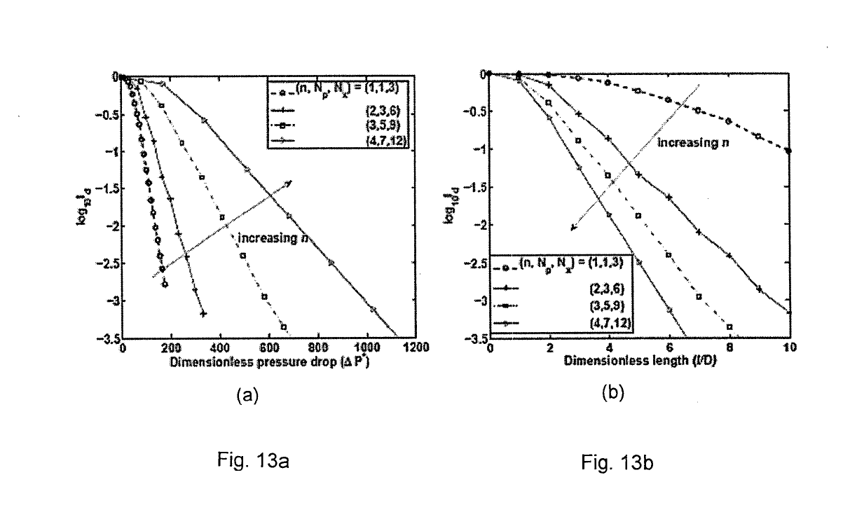

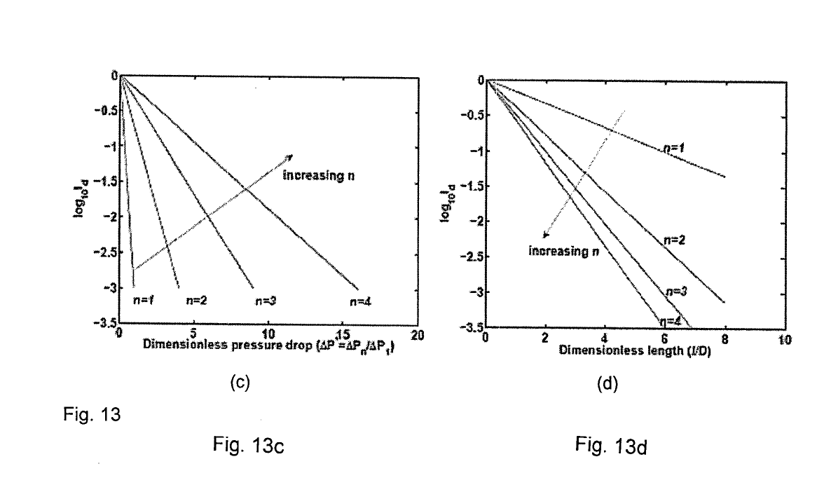

Analyzing this conclusion is done by computing mixing in the—for simplicity chosen square—channels of the (n, Np, Nx)=(n, 2n−1, 3n) series for n=1, 2, 3, and 4, respectively, see FIGS. 12 and 13. FIG. 13 depicts the computed flux-weighted intensity of segregation versus (a) and (c) pressure drop and (b) and (d) axial length; (a) and (b) calculated form the mapping results; (c) and (d) calculated using Eqs. (5) and (6), respectively. The basic unit (n, Np, Nx)=(1, 1, 3) design represents the mixer that gives best mixing for the lowest overall pressure drop (but the longest length), see FIG. 13a and the highest order (n, Np, Nx)=(4, 7, 12) design represents the most compact mixer investigated here (while of course higher values of n give even more compact mixers at costs of higher pressure drops), see FIG. 13b. Considering that the pressure drop in a rectangular channel with square cross section D, ΔP₁, when splitting the one channel into n channels with edges D/n increases to scale with:

ΔPₙ/ΔP₁˜n² (5)

and that mixing M is proportional to total interface stretching:

M˜(3n−1)^{Nelem} (6)

with Nₑₗₑₘ the number of successive elements positioned within the mixer in axial direction, we can rationalize these results, see FIGS. 13c and 13d.

Our understanding of the SMX essentially relates to the conclusion that a basic unit exist, based on which all different designs were intuitively developed without having this notion. Rather interesting further is that not one design realized in the SMX practice over all its years of use has one of the optimal structures, Np=2n−1 and Nx=3n, except for two schematic and incomplete cut-off drawings (numbers 5 and 6) in a recent patent publication EP1510247 A1. Reason is that the basic unit, our “working horse”, was never recognized. Why is the basic unit so beautiful? The (n, Np, Nx)=(1, 1, 3) design combines three crossbars, two going up, one in the middle going down (or the other way around). It shows symmetry in itself, being mirrored around the middle of the square cross section. And mirroring is important in chaotic advection.

Two examples:
The mirrored Kenics design RL-180 (right-left, co- and counter-rotating) performs in all designs with different blade twist (see Galaktionov et al., 2003) much better than its un-mirrored counterpart RR-180.
Similarly gives the mirrored Ross RL-90 LPD with its co- and counter-rotating vortices, much better results in all designs (for different crossing angles) than its un-mirrored RR-90 counterpart (see Singh et al., 2009).

Co- and counter-rotating (clock and anti-clock wise) vortices are known to be a prerequisite for global chaotic advection throughout the whole mixing domain of interest, while in only one way rotating vortices almost always give rise to the presence of KAM boundaries separating unmixed regions in the flow, forming three dimensional islands, from the well mixed regions. The basic element (n, Np, Nx)=(1, 1, 3) integrates the two counter-rotating vortices within one element. It creates 2 interfaces each with length D from the one with length D that is present at its entrance. Its stretch is basically 2, see FIGS. 11a and 12b. Of course we can integrate more than one basic element in one mixing element by putting them parallel and in series, see e.g. FIG. 11(b) and FIGS. 12(b-d).

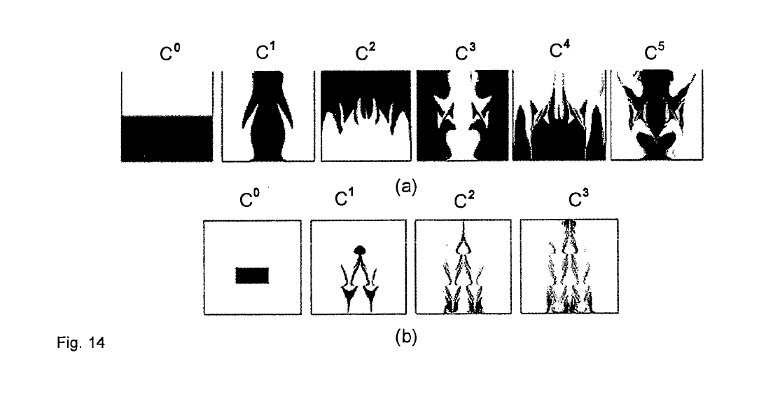

The basic element of a SMX with three vertically placed crossbars and with edges D/n, only functions properly if a horizontal interface, e.g. with length D/n, is present at its entrance. Upon passing the element, the interface is split into two parts of 0.5 D/n each by the counter rotating vortices of the secondary flow and stretched into two vertical interfaces of length D/n. Obviously if no interface is present at the entrance (but only black or only white material) the element does not function and only unnecessarily contributes to the pressure drop. If a vertical interface is entering a vertical basic element, it only rotates back, see FIG. 14a. FIG. 14a discloses flow through 5 succesive identical (n, Np, Nx)=(1, 1, 3) mixing cubes on a row. The first element stretches the interface with roughly a factor 2, changing its orientation from horizontal to vertical; but subsequent rotations in the following cubes (one quarter each) transforms the pattern formed (which does not contribute to interfacial stretching) and basically after passing 4 cubes, we arrive at more or less the same pattern that was found at the entrance of the mixer (a little bit more hairy interfaces result). Apparently only the first element functions in interface stretching and the other (n−1) elements just contribute to space and pressure consumption. This situation completely changes if materials exchange with upper and lower mixing cubes is possible, see FIG. 14b. FIG. 14b depicts the flow through succesive identical mixing cubes on a row, now forming the middle part of a (n, Np, Nx)=(3, 5, 9) mixer, illustrating that black material extends to cross the total mixer.

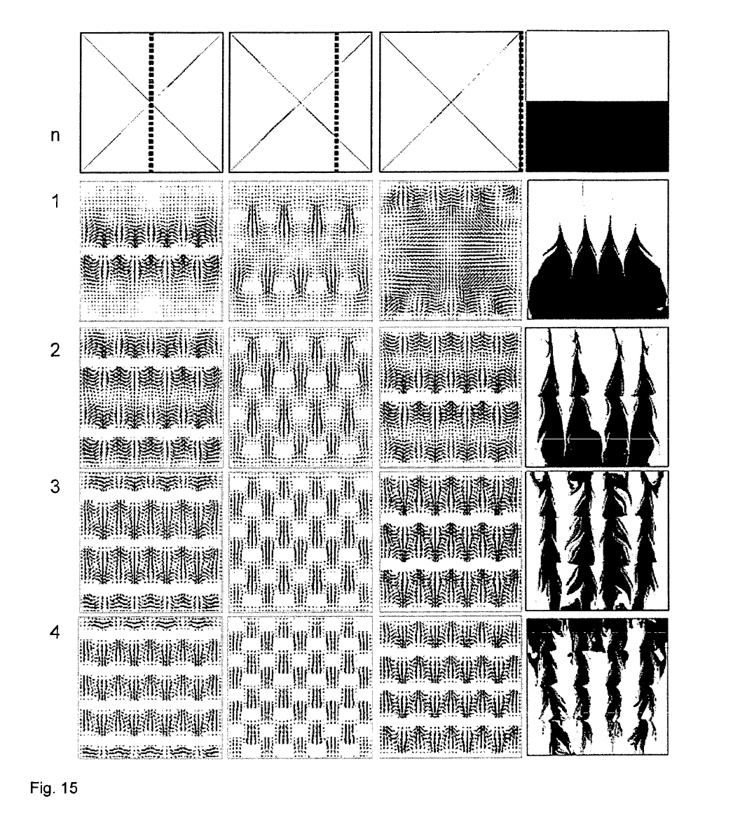

The explanation is given in FIG. 15 that shows that cooperative vortices of the secondary flow result in effective stretching of an originally horizontal interface entering the mixer in the middle. Transverse velocity vectors are shown in three different cross-sections in the first element on locations 0.5I, 0.75I, and I, for four mixers with increasing complexity given by n=1, 2, 3, 4. Under-stretching is found for n=1, 2 for the (n, Np, Nx)=(1, 1, 9) and (2, 3, 9) mixers; correct stretching for n=3, the (n, Np, Nx)=(3, 5, 9) mixer; and overstretching for n=4, (n, Np, Nx)=(4, 7, 9) mixer. Sufficient stretch is only found when the cross-section of the basic unit is square and either under-stretching results, see e.g. in the (n, Np, Nx)=(2, 3, N_{SMX}) mixers with N_{SMX}>6, in FIG. 3, and the (n, 2n−1, 9) mixers in FIG. 15 with n=1, 2, or in the opposite, which is overstretching for N_{SMX}<6 in FIGS. 3 and n=4 in FIG. 15.

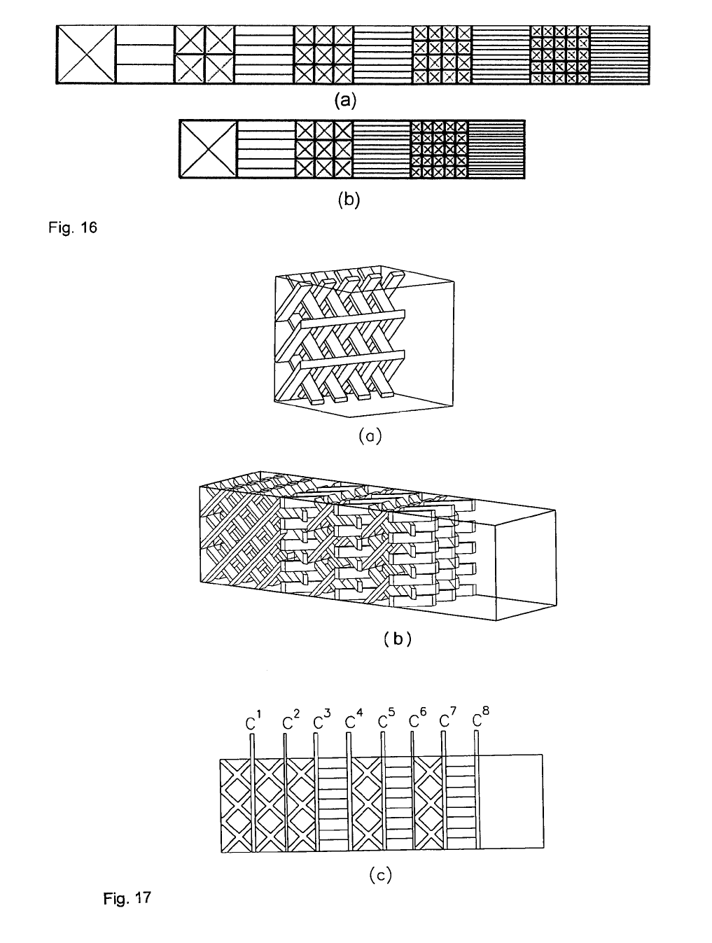

The optimum design of any motionless SMX mixer should contain only elements if interfaces with proper position and orientation are present. The first thought yields a design in which all elements with increasing order, n=1, 2, 3, 4, 5, etc. are put in a row within one mixer, see FIG. 16. FIG. 16 depicts designs of the hierarchical SMX mixer showing the combination (a) 1, 1R, 2, 2R, 3, 3R, 4, 4R, 5, 5R (b) 1, 2R, 3, 4R, 5, 6R, with the number indicating the value of n in the (n, Np, Nx)=(n, 2n−1, 3n) designs and R stands for 90° rotation in tangential direction. Interestingly, the pressure drop in this hierarchical design of the SMX, the SMX^{h}, that is focused on the mixing performance of the element with the highest value of n, but that tries to reach that with a pressure drop related to that of the lowest value of n, scales as:

ΔPₙ/ΔP₁˜n·log(n) (7)

which is substantially lower than the ΔPₙ/ΔP₁˜n² found earlier in Eq. (5) for using just higher (n) order elements comment.

However, we even can do better. Since in a mixer with order n, where at the end of the first element 3n−1 interfaces with proper orientation are entering the second (90° rotated) element, only the first n² cubes, forming the basic elements with edges D/n in the first plane of the second element, function by rotating all interfaces, while the following (n−1)*n² cubes do nothing else than consuming space and pressure.

Therefore the optimum design of every SMX mixer starts with deciding what n should be, given the maximum pressure drop available or given manufacturing limits or given stiffness requirements of the crossbars themselves. Subsequently we need a first full element obeying (n, Np, Nx)=(n, 2n−1, 3n) that acts to extend the interface entering (horizontally) in the middle of the (vertically oriented) element, into 3n−1 vertical interfaces. (This first element could if wanted partly be cut-off at the entrance on places where no interface is present or will appear and only either white or black material enters). The second element (of course 90° rotated with respect to the orientation of the first element) consist of only the first layer of n² cubes and the next (n−1) rows of in total (n−1)*n² cubes are removed. The same holds for the third, fourth, fifth, etcetera elements, see FIGS. 17b and 17c. FIG. 17 depict designs of a variety of SMXⁿ: (a) the building blok BBⁿ of the (n, Np, Nx)=(3, 5, 9) configuration, (b) and (c) the compact SMXⁿ design summarized in the formula n×BBⁿ+Nₑₗₑₘ×(BBⁿ(R)−BBⁿ), with Nₑₗₑₘ the number of elements and BBⁿ(R) the 90° rotated BBⁿ.

Neglecting pressure consumption in the first element, which is allowed for sufficiently large Nₑₗₑₘ, the length Lₙ and thus also pressure drop ΔPₙ are, in this optimized device of the SMXn, a factor 1/n lower than in all (n, Np, Nx)=(n, 2n−1, 3n) designs and, therefore, compare Eq. (5), only scales linearly with n, while the mixing efficiency, Eq. (6), remains unaltered:

Lₙ/L₁˜n⁻¹, (8)

ΔPₙ/ΔP₁˜n⁻¹, (9)

Mₙ/M₁˜((3n−½)^{Nelem} (10)

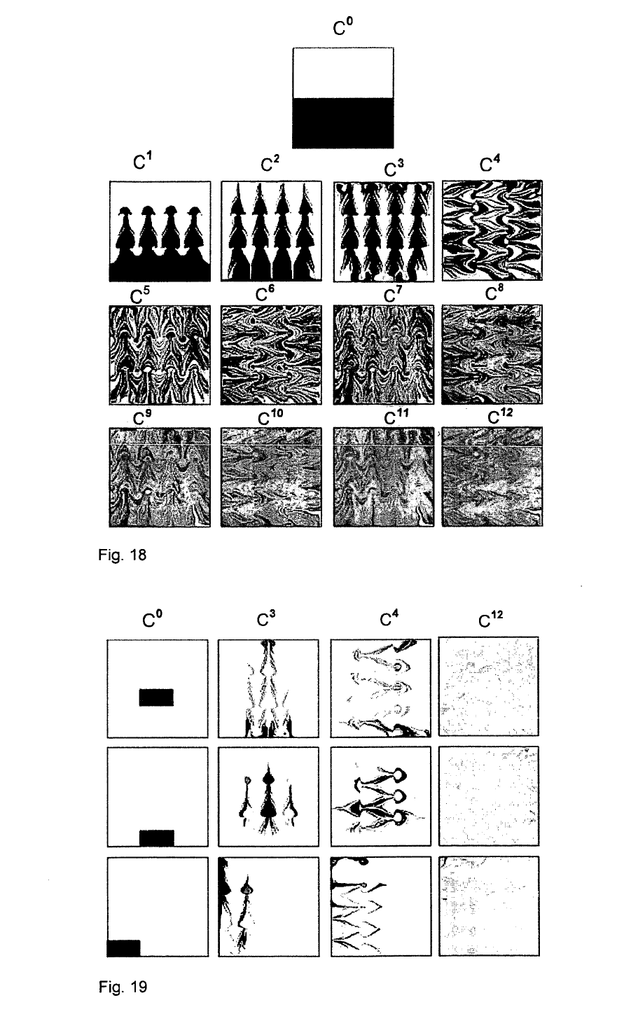

Mixing efficiency in the SMXⁿ design is demonstrated in FIG. 18 for n=3. FIG. 18 depicts mixing in 4 elements of the optimal design SMXⁿ Mixing snapshots after each ⅓ element of the (n, Nₚ, Nₓ)=(3, 5, 9) based SMXⁿ mixer with θ=120°, build up with planes of n² cubes, normal (N) and 90° rotated (R), in the sequence: (Element 1), (Element 2), (Element 3), (Element 4): (N, N, N), (R, N, R), (N, R, N), (R, N, R).

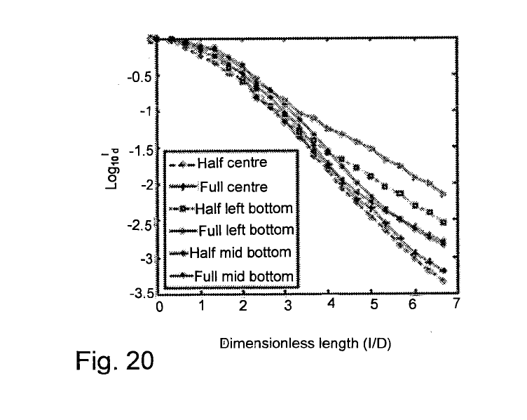

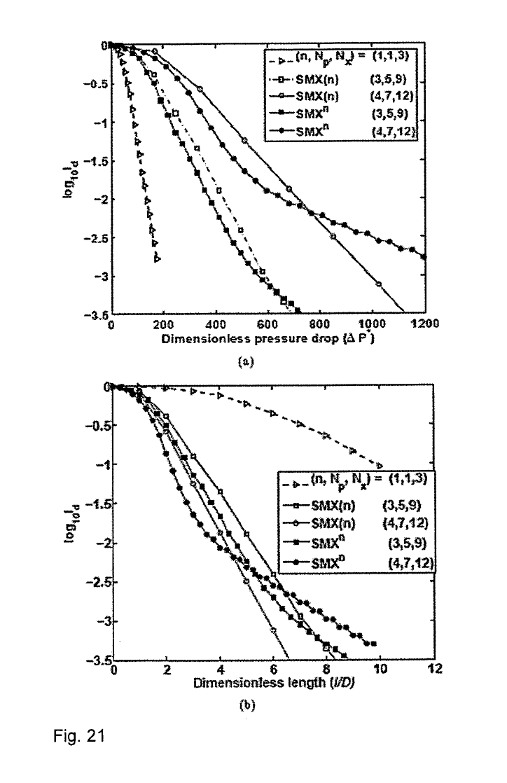

The influence of the injection location is demonstrated in FIGS. 19 and 20, illustrating that injection somewhere in the middle gives the best results. FIG. 19 depicts the effect of injection location on mixing in SMXⁿ of FIG. 17. FIG. 20 depicts the determination of injection location to achieve best mixing using different initial conditions. Black material is injected in the center cube, bottom cube and the left corner cube, either fill or half as demonstrated in FIG. 19 for the half filled cubes.

Although the SMXⁿ is indeed is the most compact but effective SMX mixer possessing the lowest possible pressure drop, a closer examination of its performance reveals its limitations, see FIG. 21. FIG. 21 depicts a comparison between SMX(n) and SMXⁿ (a) Intensity of segregation versus dimensionless pressure drop and (b) versus dimensionless length. FIG. 21a demonstrates that from the optimal design series of the SMX(n) (n, Np, Nx)=(n, 2n−1, 3n) the most simple mixer, our basic unit and working horse (1, 1, 3), provides the best mixing at the lowest pressure drop. However, given its long length, see FIG. 21b, it should not so much be compared with higher complexity SMX(n) mixers, (n>1), but more with Kenics or Ross LPD mixers. Now we compare the SMX(n) with the SMXⁿ design. Both are indeed very compact mixers, see FIG. 20, and the higher the value of n the more compact the mixer is. Also recognizable is that, certainly in initial stages of mixing, the SMXⁿ outperforms the SMX(n), both in compactness and energy consumption. However, after a while, sooner for higher values of n, a change in slope is found, disappointingly almost approaching that of the (1, 1, 3) mixer line, see FIG. 21b. This can be understood since a change from global mixing (first n elements of the SMXⁿ mixer) to local mixing (following rows of elements) could ideally only be done if the average concentration entering each individual cell of the local mixers would be equal to the average concentration in the total domain. And that is apparently not yet reached after one first full element.

Quantitative mixing analyses based on the Mapping Method applied on motionless SMX™ mixers teach that optimal interface stretching only happens within an element that is build from basic units with a square cross section. Deviations from this local square cross section yield either under-stretching or over-stretching of the interface within one element, which both is bad for optimal mixing. The most simple example is the n=1 design, thus Np=1 with three crossing bars (Nx=3). When the crossing angle is chosen 90° then the basic unit is even a simple cube. When the angle is chosen larger, for slightly better interfacial stretching and lower pressure drop per element, the basic unit extends to a cuboid. One very interesting exception on the general design rule was found in FIG. 8, but only for some of the most simple designs with n=1. If n=1, the walls can still effectively influence the transverse flow. An increase in interface stretch can be realized even if the optimum ratio of Np/Nx is not present. But this was only true for the (1, 1, 4) design and for the (1, 1, 6) design interface stretch remained sub-optimal, even if the crossing angle θ had been increased to 140°. The reason why this exception is indeed very interesting is that the four crossbars present in the (1, 1, 4) mixer rotate the fluids with two counterrotating vortices such that, like in the Kenics mixer (see Galaktionov et al. 2003) an extra interface is created in the middle at the end of each element. This most simple, thus n=1, (1, 1, 4) with crossing angle θ>90° configuration of the SMX designs results in a very energy efficient mixer design.

Based on the scalable (1, 1, 3) basic unit, more complex optimal mixers can be build, just by changing the value of n to n=2, 3, 4, . . . in the (n, Np, Nx)=(n, 2n−1, 3n) series, where wall effects are not present and needed. High values of n yield more compact mixers. The SMX design series obeying this rule represents a very compact mixer design.

Finally, both the hierarchical SMX^{h} and the extreme compact SMXⁿ initially yield better results in terms of mixing quality reached within short lengths, but when extremely high mixing qualities are required, thus rather low values of log(I) (the discrete, cross section averaged, flux weighted intensity of segregation), then the SMX(n) proves to remain superior.

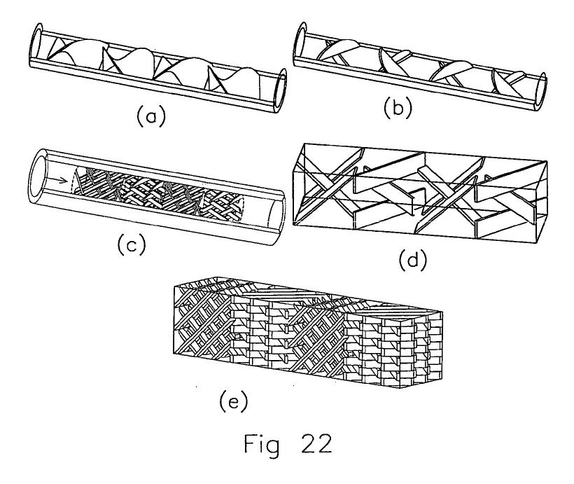

FIG. 22 depicts different motionless mixers 22a the Kenics mixer (RL configuration), 22b the Ross LPD mixer (RL configuration), 22c the standard Sulzer SMX™ mixer (the (n, Np, Nx)=(2, 3, 8) configuration), and finally two examples of the new design series of the most efficient SMX(n) mixer with (n, Np, Nx)=(n, 2n−1, 3n) shown here in their rectangular configuration 22d the working horse (1, 1, 3), and 22e the compact (3, 5, 9).

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. For example the invention may relate to a static mixer complying with basic elements that are, like in every motionless mixer, axially alternating in a 0 and 90 degrees rotated fasion placed in a channel, and that are following the formula (n, Np, Nx)=(n, 2n−1, 3n) wherein n represents the number of parts the height of the channel and the width of the channel, with square or circular cross section is split in (indicating the complexity of the mixer by just one number n=1, 2, 3, 4, 5, 6, etc.) Np is the number of parallel crossbars along the length of one basic element of the mixer, and Nx is the number of cross bars over the width of one basic element of the mixer. It further relates to a static mixer constituted of building blocks, forming one layer of n*n cubes, causing n succesive building blocks, axially placed in the channel to form one basic element, where after the first thus formed basic element only alternating (0 and 90 degrees rotated) building blocks follow. Comparing realized to optimal stretching, we find the optimum series for all possible SMX(n) designs to obey the universal design rule Np=(⅔)Nx−1, for Nx=3, 6, 9, 12, . . . .

The descriptions above are intended to be illustrative, not limiting. Thus, it will be apparent to one skilled in the art that modifications may be made to the invention as described without departing from the scope of the claims set out below.

1. A static mixer provided with a mixing element for use in a channel, wherein the mixing element comprises crossbars and the number of parallel crossbars Np along the length of one mixing element and the number of crossbars over the width of the mixing element Nx are related by the formula:
Np=(⅔)Nx−1.

2. The mixer according to claim 1, wherein the mixer comprises multiple mixing elements, each mixing element comprising crossbars according to the formula:
Np=(⅔)Nx−1.

3. The static mixer according to any of claims 1 to 2, wherein the mixing element comprises crossbars according to the formula (n, Np, Nx)=(n, 2n−1, 3n), wherein n is 1, 2, 3, 4, 5, 6, etc.

4. The mixer according to claim 3, wherein n is 1.

5. The mixer according to claim 3, wherein n is 2.

6. The mixer according to claim 3, wherein n is 3.

7. The mixer according to claim 3, wherein n is 4.

8. The mixer according to claim 3, wherein n is 5.

9. The mixer according to claim 3, wherein n is 6.

10. The static mixer according to any of claims 1 to 2, wherein the mixing element comprises crossbars according to the formula (n, Np, Nx)=(n, 2n−1, 3n), wherein n is chosen from the group comprising 1, 2, 3, 4, 5, and 6.

11. The mixer according to any of claims 3 to 10, wherein n is an integer larger or equal to one and n is the number of crossbars which can be provided in the length of the mixing element parallel to a flow direction in the channel.

12. The mixer according to claim 11, wherein n is the number of crossbars which can be provided in a direction perpendicular to the length and the width of the mixing element.

13. The mixer according to any of claims 2 to 12, wherein subsequent mixing elements of the multiple mixing elements are rotated with respect to each other 90° around an axis parallel to the length of the mixing element.

14. Method of mixing a fluid in a channel comprising:
inducing a flow to the fluid through the channel; and mixing the liquid with a mixing element, wherein the mixing element comprises crossbars and the number of parallel crossbars Np along the length of one element (claim 1 as filed) and the number of crossbars over the width of the element Nx (claim 1 as filed) are related by the formula:
Np=(⅔)Nx−1.

15. Use of the following formula in the design of a mixing element with crossbars for a static mixer:
Np=(⅔)Nx−1
wherein Np is the number of parallel crossbars along the length of one element and Nx the number of crossbars over the width of the element Nx is.
